(19) United States
(12) Patent Application Publication
(10) Pub. No.: US 2005/0024858 A1
(43) Pub. Date: Feb. 3, 2005

(54) Container illumination

(76) Inventor: Richard Johnson, San Diego, CA (US)

Correspondence Address: Burkhart & Burkhart;Patent Attorneys, 940 Dakota Avenue, Whitefish, MT, 59937, US

(21) Appl. No.: 10/891,698

(22) Filed: Jul. 14, 2004

Related U.S. Application Data
(60) Provisional application No. 60/487,714, filed on Jul. 14, 2003.

(51) Int. Cl. F21V 33/00

(52) U.S. Cl. 362/154

(57) ABSTRACT

A container illumination assembly for use with a standard includes a selectively actuatable light source. A connection mechanism is adapted and constructed to secure the light source to the standard container. With the light source secured to the standard container with the connection mechanism, the contents of the standard container are selectively illuminated by the light source when the light source is actuated.

### FIELD OF THE INVENTION

The present invention relates generally to novelty consumer lighting assemblies, specifically the illumination of handheld containers.

### BACKGROUND OF THE INVENTION

There are few things that fascinate and entertain like unexpected light up objects. Since the invention of the incandescent light, millions of people have been entertained with Christmas tree lights, lights up toys, and hundreds of other consumer novelty light up devices. There have been thousands of variations regarding the design and implementation of novelty light up devices. Recently with the trend of decreasing LED lighting prices throughout the world, producers are marketing numerous novelty products for increased entertainment, utility and enjoyment in dark areas.

Known illuminating container assemblies are limited to exterior holding devices, primarily related to beverage holders and the like. For example, U.S. Pat. No. 6,352,352 Schletterer, et al. is directed to a luminescent container with quick-charging power source in which a drink container, such as a drinking glass, drinking cup, a vase, or a bottle, is illuminated with an LED. The power for the LED is supplied by quick-charging capacitors which are integrated in a cavity of the container together with the LED. The LED is disposed in a wedge-shaped recess which effects advantageous distribution of the light through the obliquely inclined walls. The capacitors are typically charged within a matter of seconds and they have a virtually unlimited cycle life.

U.S. Pat. No. 5,743,620 Rojas, et al. shows a body-worn lighted drinking receptacle 10 designed to be suspended from the belt 50 of a user by a belt clip unit 13. The drinking receptacle 10 includes a generally translucent receptacle member 20 having an illumination source 31 operatively associated with its bottom portion, and an opaque upper portion 24 which blocks the transmission of light from the illumination source 31.

In another example, U.S. Pat. No. 6,065,848 Tucker, shows base, for use with and for illuminating the interior of a container for liquids, and which has a bottom wall portion at least partly transparent to light, comprising a main body comprised of an upwardly-disposed side wall whose height is substantially less than that of the container, a bottom wall adapted to carry, or having holder structure for holding, at least one battery in a substantially horizontal position, a mount for a light bulb, electrical conductors and support structure for supporting a container thereon, to illuminate the interior of a container supported on the base through the container bottom wall portion. The base can include securement structure for securing the base to the container to reside under its bottom end portion so that when the container is lifted, the base is lifted with the container.

U.S. Pat. No. 5,504,663 to Tucker deals with a container adapted to include a light source. Containers or closures, preferably for liquids, are provided having means for holding a light source for illuminating the containers, preferably the interior of the containers. The holding means can be associated with any portion of the container, including its closure, body, side wall(s), handle, or bottom, which can include a base portion or bottom extension. The holding means can include an opening defined by a ledge in the closure, or it can include a housing which can extend upwardly or downwardly from the closure, or bottom or bottom extension. At least a portion of the container which is between the light source and the interior of the container is a least partially transparent to light

Another such item is described in U.S. Pat. No. 6,286,719 Haines, in which an Illuminated beverage container that combines the functions of a battery powered light and a water or beverage dispenser into one item. A large liquid container is located on the top and has a removable lid for cleaning and filling. A handle, suitable for hanging, is provided at the top of the container as well. A pouring spout is located on the circumference of the container toward the lower edge and functions in the customary manner. A base is provided for the container which houses a fluorescent or incandescent lamp, batteries, a switch and associated electrical components to allow the lamp to illuminate. The lamp is located such that it provides light directly into the liquid container.

Similarly, U.S. Pat. No. 4,344,113 to Ditto describes a device for illuminating a liquid drink for use at a party or a social event to give the appearance of an illuminated liquid. The device has a light adapted to colimate a beam of light through the transparent bottom of the glass receptacle into the liquid and be dispersed therein. Rechargeable or non-rechargeable batteries are secured within the base to act as a power source for the light. A switch means comprising of upwardly contacts to contact a conductive ring of the base of the glass receptacle forms the on or off means for the switch. A modified form would utilize a coaster which may be used with stem ware and would be activated by the weight of the glass upon the coaster. The still modified form would be formed by a manual operated switch which may be used with the light formed in a chamber formed in the box under the glassware. A charger base utilizing inductive principles is used to recharge rechargeable batteries if used in that particular embodiment.

Unfortunately, known illuminating devices are limited to specific container sizes or configurations. It can be seen from the foregoing that the need exists for a versatile illumination kit that overcomes the shortfalls of known arrangements in this technology.

### SUMMARY OF THE INVENTION

In accordance with the principles of the present invention, a consumable products container illumination kit is disclosed. The container illumination kit includes one or more of the following: a stick/on peel/off reflective lighting source label, a pre-molded snap/in snap/out lighting assembly, a squeezable application tube, a bottle and aluminum can, each constructed with a pocket, cavity or pouch designed to accept a snuggly fitted lighting source therein, thus illuminating the interior and contents of the tube, bottle and can, a stretchable elastic strap-on adaptive light source holder designed to sustain a lighting source snuggly in place around the circumference of a container with variable elastic pressure, and a self sealing illuminating plug that with applied force, pierces and penetrates aluminum, paperboard or plastic containers thus illuminating the interior and contents. With the understanding that consumer containers come in a large variety of shapes, materials, grades and sizes, the following embodiments are disclosed.

In one embodiment, the kit contains various adaptive container illumination assemblies and devices allowing the user to choose the best suited means and or assembly to illuminate a handheld disposable consumer container. The containers may be designed to hold liquids or solids ranging from opaque to transparent.

In another embodiment, the kit contains a variety of container labels each designed to hold a suitably sized lighting source snugly in place between the label and container. The label includes an adhesive and can be made of reflective flexible, positionable materials to enhance and direct the light source toward the interior and contents thereof. A light source can be activated by extending pressure upon the label or other circuit means. Further the label can contain an integrated circuit to vary the performance of the lighting source as relates to blinking, or duration of operation. The adhesive illuminating label can be placed on any suitable location on a container such that a passage of light or beam can be transmitted from the light source to the interior of the container. It is anticipated that the label can be made of paper, plastic, metal foil, Mylar and other suitable pliable materials.

In another embodiment a squeezable tube is designed with a pocket, cavity or pouch to allow the temporary or permanent insertion of a lighting source. The pocket, cavity or pouch may also be fitted with a means to permanently or temporarily seal the lighting source inside the pocket, cavity or pouch, such as a zip-lock, zipper, button, Velcro or other sealing means. After insertion and circuit activation, the lighting source will illuminate the contents of the squeezable tube and also illuminate the contents as they are squeezed out of the tube, thus creating an entertaining illumination effect. It is anticipated that this embodiment would be well-suited toward tube dispensed frozen confections, toothpaste, hair-care products, candy confections, creams, gels, and other suitably viscous tube dispensed consumer products. It is anticipated that more solid or firm containers such as rigid plastic, glass or aluminum containers would be fit with a cavity designed to sustain and hold an inserted illumination source snugly in place. These types of containers could provide illumination for liquids, shampoos, auto products, food products and other consumable products dispensed from cans or bottles.

In another embodiment a self sealing container piercing light emitting tube or rod is forcibly inserted into an aluminum or plastic container. This particular embodiment is designed to illuminate the interior and contents of an opaque container. One version of this embodiment calls for the shaking of a carbonated beverage can, and upon insertion of the illumination tube, the pressurized carbonated beverage spews out forcibly through the tube with said liquid glowing and illuminated from the light beam in the tube creating and exploding illuminated liquid effect from the can. It is anticipated that the self-sealing aspect of the piercing tube or rod includes a plug assembly to suitably seal the contents of the container. One of the main more practical utilities of this embodiment is the capability of viewing the remaining contents of a sealed opaque container.

In another embodiment the lighting source is contained within a stretchable elastic strap or band. The strap is stretched around the circumference of a container and held firmly in place allowing the transmission of a light beam to transmit from the light source or illumination assembly to the interior and contents of the container. The light source can be uni or omni-directional illuminating primarily just the inside of the container or both inside and proximal atmosphere.

In another embodiment the lighting source is contained within a non-resilient strap sealed by button, snap, Velcro, adhesive, rivet or other lacking means. The strap is placed around the circumference of a container with a light source positioned to transmit light to the inside of a container, thus illuminating the contents therein.

In another embodiment, containers are molded with form fitted indentations suitable to place an LED light, batteries, circuit board and pushbutton. The label is then placed over the inserted parts fitting flush over the container with limited protrusions or bumps from under the label. This particular embodiment requires a custom molded part, but would provide the mass markets with a consistent performing and smooth fitting illumination label means.

In another embodiment an illumination clip, clips onto the mouth of a bottle, cup or can. The clip can be formed to enhance the pourability of the container, thus reducing spills or drips when poured. This design allows users to illuminate opaque containers such as cans or detergent containers. The combination of a clip on container illumination device with an easy-flow transitional spout feature, creates an added an unexpected utility.

In addition to the entertainment value of the present invention, there are other aspects as well. The containers could also be utilized as nightlights for washrooms, bedrooms and hospitals. The multi-adaptable container lighting assemblies could be utilized for advertising, promotional uses, games, contests, further displaying print, graphics or other art, and other novelty printed items revealed by illumination both of the interior and exterior of the container. The invention itself, however, both as to organization and method of operation, together with further objects and advantages thereof, may be best understood by reference to the following description taken in conjunction with the accompanying drawings.

### BRIEF DESCRIPTION OF THE DRAWINGS

FIG. 1 represents a schematic of an illumination sticker or label embodying the principles of the present invention.

FIG. 2 represents the application of a the FIG. 1 illuminating label on a cylindrical container.

FIG. 3 illustrates label or sticker illumination components from the inside as applied on a cylindrical container.

FIG. 4 illustrates a schematic of an illuminating tube container embodying the principles of the present invention.

FIG. 5 illustrates a plastic bottle with a preformed indentation molded into the container for the application of a illuminating sticker or label embodying the principles of the present invention.

FIG. 6 is a drawing of a strap or band with a built-in illuminating mechanism embodying the principles of the present invention.

FIG. 7 is a drawing of a container piercing illumination device embodying the principles of the present invention.

FIG. 8 is a drawing of a “clip on” container illumination device embodying the principles of the present invention.

FIG. 9 illustrates an embodiment of a video container illumination device embodying the principles of the present invention.

FIG. 10 illustrates another embodiment of a video container illumination device embodying the principles of the present invention.

### DETAILED DESCRIPTION OF PREFERRED EMBODIMENTS

While this invention is susceptible of embodiment in many different forms, there is shown in the drawings, and will herein be described in detail, exemplary embodiments, with the understanding that the present disclosure is to be considered as illustrative of the principles of the invention and not intended to limit the invention to the exemplary embodiments shown and described.

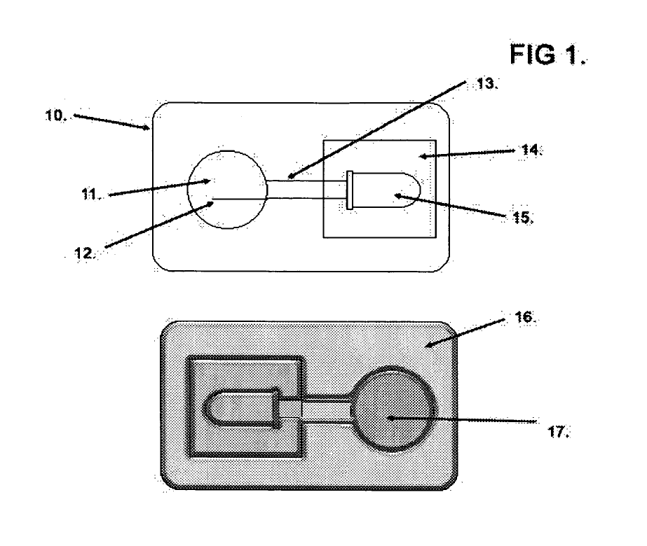

FIG. 1 represents a schematic of an illuminating flexible sheet, which can be provided in the form of an adhesive sticker or label. The label or sticker, 10 can be made of a suitable material such as paper, plastic or metal foil and may optionally contain preformed foam indentations to ideally fit the size and shape of the light assembly components. The components of the light source assembly are systematically stuck to, or into the label perforations as either preformed or by an adhesive. The sticker or label is applied to a container and may be activated by a battery and switch source 11, connected to electrically conductive leads 12, and 13 and an LED light or other light source 15. In the illustrated example, the light source 15 is housed within a reflective holding assembly 14. It is to be understood that the present invention contemplates mounting of the light source in any suitable casing. A three-dimensional illustration is represented by 16, and form fitted indentations are shown by 17. Such form fitting (such as foam) or preformed three-dimensional designs, will help smooth the irregular contusions protruding from under of the label or sticker. It is anticipated that the shape of the light emitting source or bulb can take the form of round, square, or resemble the shape of a coin or stamp. It is also anticipated that such light emitting sources and battery components will take on various shapes as technology directs, thereby enhancing the practical utility and application of this illuminating sticker or label. It is further anticipated that this preferred embodiment would be suitable for the illumination application of any type of container such as a can, tube, bottle, glass, pouch, bag, plastic food container box, box with a window, or cup.

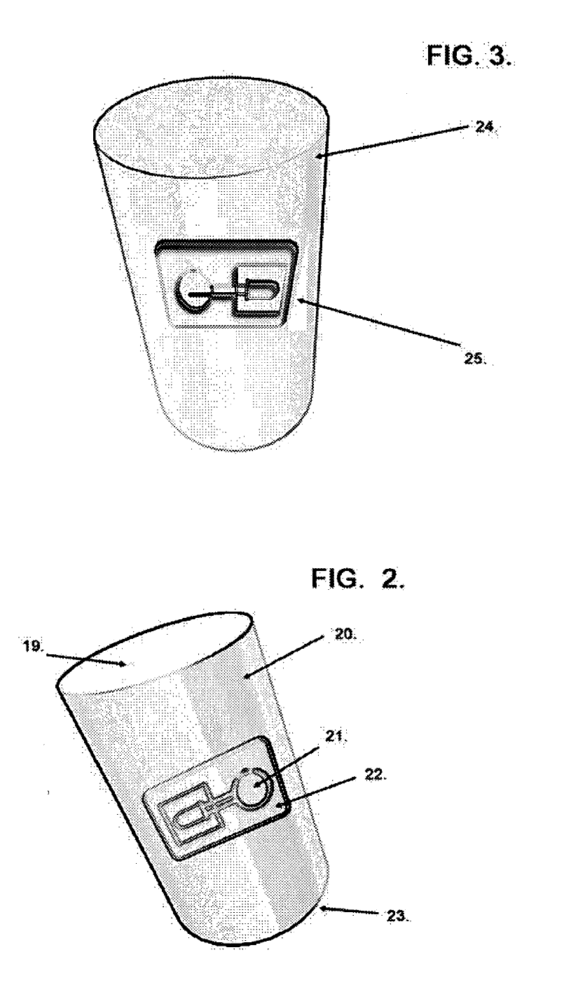

FIG. 2 represents an application of a the illuminating label or sticker 22, as applied on a cylindrical container 20. An illuminating sticker or label could optionally be placed on the top of the container 19, or the bottom 23. In this preferred embodiment, the illuminating sticker is activated by a pushbutton switch 21. As shown in this design, the sticker or label protrudes slightly from the container. The light assembly components are located inside and underneath printing side of the label, fitting flush on exterior to reduce component lumps protruding from underneath. The light source components are placed inside form fitting cavities formed within the back adhesive side of the sticker or label. The components are fitted snugly in the foam or preformed cavity so both the adhesive and exterior (print side portion) of the sticker or label are even and f lush.

FIG. 3 shows the label or sticker illumination components from the inside 25, as applied on a cylindrical container 24. In this embodiment, the illustration shows the indentations and form fittings of the light assembly components prior to the application of the printed exterior cover.

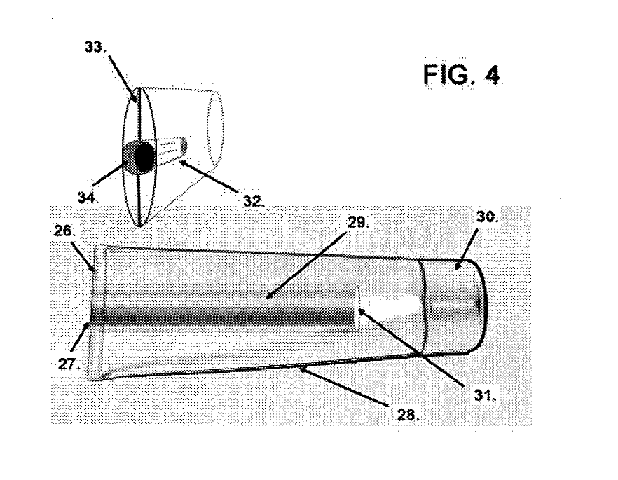

FIG. 4 represents schematic and three-dimensional views of an illuminating tube container 28. A light transmission element 29, contains a light source and light assembly components such as a battery, circuitry and switch. The light transmission element is placed inside a cavity or pouch 34. A switch can be located toward the bottom of the tube 27. Optionally the light transmission source can be sealed inside the tube via a sealing means 26 and 33. In this embodiment, the light transmission element may be of variable lengths as utility and tube size suitably permits, with light emanating from the interior portion 31. When the cap 30, is removed the liquid components inside the tube are also illuminated as they are squeezed from the tube 28. 32, shows the three-dimensional interior view of the light transmission element. It is anticipated that the consumable contents of the tube can range from candy confections, toothpaste, hair-care products, paints, novelty goo, and many others.

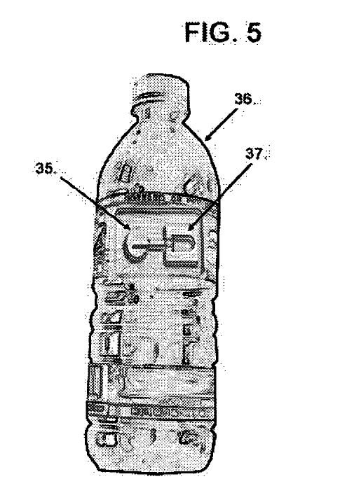

FIG. 5 is a drawing of a plastic bottle 36, with a preformed indentation 37, molded into the container for a snap-in or adhesive applied illuminating sticker or label 35. In this embodiment, a plastic container is molded such that a pre-designed illumination means may be precisely snapped into or stuck into place onto the plastic container. This design provides a perfect fit for a specifically matched designed illuminating component assembly. The illuminating component may be interchanged from one container to the next, allowing for multiple uses. It is anticipated that consumers will purchase a quantity of container product, such as a six-pack of water, soda or beer, and utilize the interchangeable illumination snap in/on—sticker or label for each container. The preferred embodiment for this pre-molded design application could apply to plastic, glass, or metal containers.

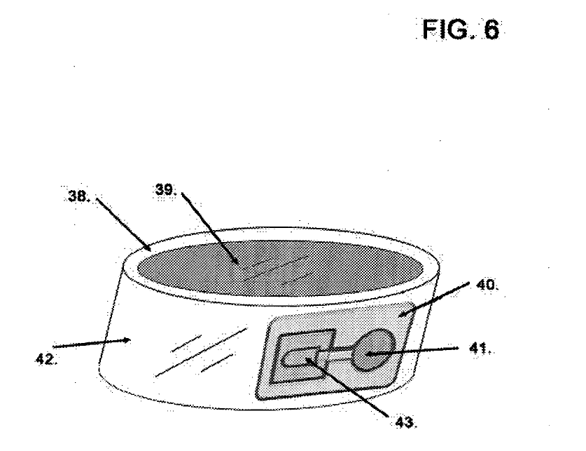

FIG. 6 is a drawing of an illuminating strap or band assembly, 42, with a built-in illuminating means 40. The strap 38, wraps or stretches around a container and may utilize elastic, Velcro, buttons or other means to secure the strap firmly around the container which would be placed inside the strap in the space of 39. The lighting assembly 40, contains a reflective illumination source, a bulb 43, and a housing for batteries and a switch 41. It is contemplated that the preferred embodiment would attach to a cylindrical container much the same as a wrist-band stretches onto a wrist. The interior portion of the band is constructed to allow the passage of light from the light source to the container utilizing a transparent window stitched into the band or an opening at the light source bulb. This container illumination design allows users to easily transfer from one container to the next with a variation of container sizes. It is further contemplated that the band could include printed graphics and other advertising messages on exterior and interior of the band.

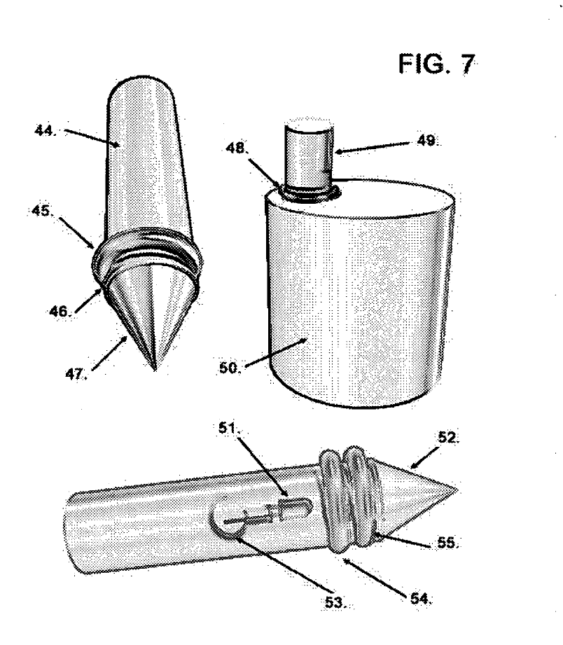

FIG. 7 is a drawing of a container piercing illumination device and applications thereof. In this embodiment a cylindrical container piercing illumination device is shown. The device includes a pointed tip 47, a light transmission housing source 44, one or more container sealing rings, 45, 54, and 55. The device also includes an optional positional stabilizer 46 which may include a series of threads for tightening. Light is transmitted through the transparent piercing tip, 52. Batteries and switch 53, and the light bulb 51, are located in the light transmission tube, 44. A surface of the container, such as an end wall of a sample cylindrical can shaped container 50, is pierced by the container piercing illumination assembly 49, and sealed to prevent leakage after piercing by an O-ring, 48. It is also contemplated that the piercing device can be used to penetrate a side wall of the container as desired. This embodiment of this illumination device is designed to illuminate containers such as aluminum cans and various plastic, paperboard, cardboard, sacks, bags, and pouches, whether they are fabricated from opaque, translucent, or transparent materials. It is contemplated that this device will be utilized in a similar fashion as a pouch piercing straw often used in juice-box drinks. It is further contemplated that the pouch piercing illumination device will include a combination drinking straw to illuminate the contents of a juice box as they are being drawn into a drinking straw, thus lighting the box, it's interior and the straw.

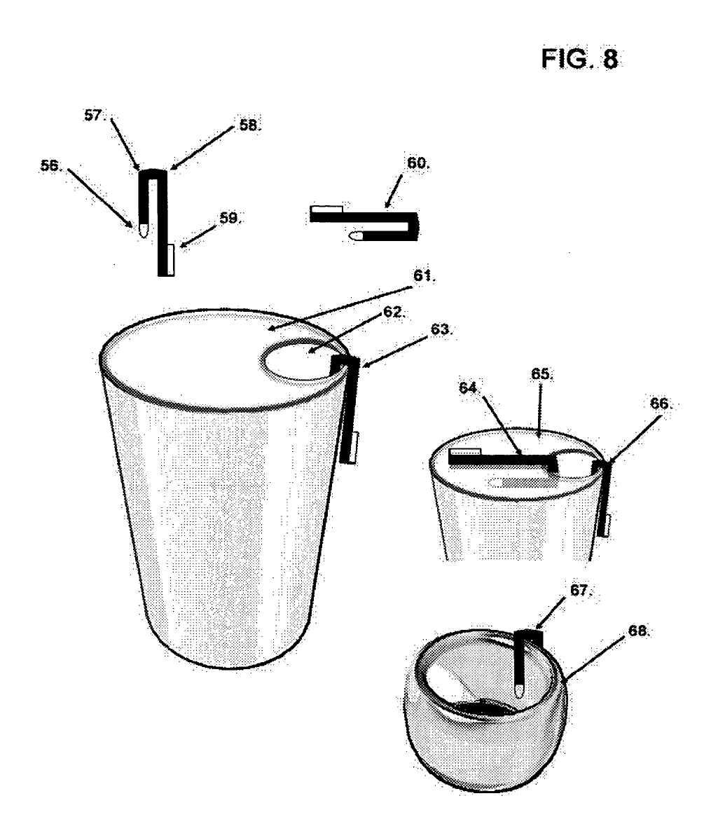

FIG. 8 is a drawing of a “clip on” container illumination device 60, and applications thereof. In this preferred embodiment, a clip on illumination device is shown including a lighted tip source 56, a primary angular bend, 57, a secondary bend 58 and a battery and switch 59. The primary and secondary bends are designed to create spring tension thus holding the clip in place. There are numerous practical applications as illustrated by illuminating an aluminum can 61, whereby a clip-on device 63, is clipped onto the can through the hole, 62. 65 represents two different placements for the clip illustrated by a side mount position 66, and a top mount position 64. Further, the illuminating clip can be clipped onto various cups or drinking glasses as illustrated by a cup, 68 with an illuminating clip 67, attached thereto. It is anticipated that a semicircular rounded clip can-hole fitting, designed with rounded edges could also provide the additional combination utility of enhancing the liquid flow, thereby “spill-proofing” the transitional flow of liquid from the container to one's mouth for drinking purposes. As a secondary design, the clip could include a drinking straw means, whereby liquids are drawn up through a light transmission tube attached to the container illumination clip. As described, this design creates a smoother liquid transitional flow, and lights the contents of the container simultaneously.

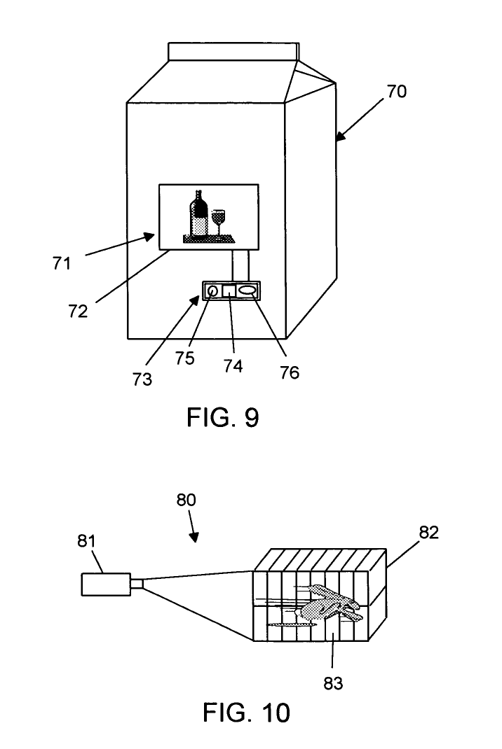

Another embodiment of the present invention is illustrated in FIG. 9. In this embodiment, a container 70 is provided with an illumination source in the form of a dynamic display assembly 71. The dynamic display mechanism can be provided in label form as shown, and is capable of supplying video, animation, slideshows, static video display, or other dynamic visual information. The dynamic display assembly 71 is adhered to the container 70, and includes a screen 72, which is shown as a flexible digital video screen, such as a plasma screen. A content and power source 73 includes a source of digitized video information 74, which can be provided as a digital computer chip. Power can be provided in a known manner, as by batteries 75. The content and power source 73 can also be provided with audio capabilities, including a speaker 76, to facilitate audio content in conjunction with video.

In an alternative embodiment shown in FIG. 10, the dynamic display mechanism is illustrated in the form of motion picture video information 80 from a standard video projection arrangement 81 employed to illuminate one or more containers 82. The surfaces of the containers 82 facing the projection arrangement 81 are provided with a film surface 83, fabricated from material similar to that used in screens for large television displays. The projection arrangement 81 can be placed in a suitable, unobtrusive location (e.g., across the aisle or on the ceiling in a retail store), and actuated to project onto several containers. It is contemplated that this embodiment will find particular utility in point-of-sale promotions and the like.

The foregoing is merely exemplary of the concept of container lighting devices. There are several potential variations in which the user can interact with printed materials, games, films or papers as collectibles. While details of the invention are discussed herein with reference to some specific examples to which the principles of the present invention can be applied, the applicability of the invention to other devices and equivalent components thereof will become readily apparent to those of skill in the art. For example, games can be incorporated using printed materials to find hidden treasures embedded within various containers. Printed information can provide instruction for schoolchildren, including math, science, history and even entire books can be miniaturized and printed materials included with the containers. Further, there are an unlimited variety of graphics and art that can be created and manipulated utilizing the preferred embodiments disclosed herein.

Although the present invention has been described with reference to specific embodiments, those of skill in the art will recognize that changes may be made thereto without departing from the scope and spirit of the invention as defined by the appended claims.

1. A container illumination assembly for use with a standard container, the illumination assembly comprising the following:
a selectively actuatable light source; and
a connection mechanism adapted and constructed to secure the light source to the standard container;
whereby, with the light source secured to the standard container with the connection mechanism, the contents of the standard container are selectively illuminated by the light source when the light source is actuated.

2. An illumination assembly in accordance with claim 1, wherein the connection mechanism comprises a flexible sheet.

3. An illumination assembly in accordance with claim 2, wherein the connection mechanism comprises an adhesive label.

4. An illumination assembly in accordance with claim 1, wherein the connection mechanism comprises a sealed, flexible tube secured within the container.

5. An illumination assembly in accordance with claim 1, wherein the connection mechanism is secured within an indentation on the container.

6. An illumination assembly in accordance with claim 5, wherein the connection mechanism is secured within an indentation on the side of the container.

7. An illumination assembly in accordance with claim 5, wherein the connection mechanism is secured within an indentation on the bottom of the container.

8. An illumination assembly in accordance with claim 1, wherein the connection mechanism comprises a substantially contiguous band.

9. An illumination assembly in accordance with claim 1, wherein the connection mechanism comprises a piercing member adapted and constructed to penetrate a surface of the container.

10. An illumination assembly in accordance with claim 9, wherein the connection mechanism comprises a piercing member adapted and constructed to penetrate a wall of the container.

11. An illumination assembly in accordance with claim 9, wherein the piercing member comprises a sealing mechanism to affect a seal between the container surface and the piercing member when the piercing member is inserted into the container.

12. An illumination assembly in accordance with claim 1, wherein the connection mechanism comprises a clip-on mechanism adapted and constructed to be selectively connected to the container.

13. A method for container illumination, the method comprising the following steps:
providing a container;
providing a selectively actuatable light source; and
securing the light source to the container using an adhesive;
whereby, with the light source secured to the container, the contents of the container are selectively illuminated by the light source when the light source is actuated.

14. A container illumination assembly comprising the following:
a container; and
a dynamic display mechanism adapted and constructed to provide dynamic visual information on a surface of the container.

15. An illumination assembly in accordance with claim 14, wherein the dynamic display mechanism comprises a video screen on a surface of the container.

16. An illumination assembly in accordance with claim 15, wherein the dynamic display mechanism comprises a label secured to a surface of the container.

17. An illumination assembly in accordance with claim 16, further comprising a content source secured to the container and connected to the video screen.

18. An illumination assembly in accordance with claim 17, wherein the content source comprises a digital chip.

19. An illumination assembly in accordance with claim 14, wherein the dynamic display mechanism comprises a projection surface on the container adapted and constructed to facilitate viewing of externally projected video images.

20. An illumination assembly in accordance with claim 19, wherein the projection surface is adhered to the container.
